(19) United States
(12) Patent Application Publication
(10) Pub. No.: US 2024/0050954 A1
(43) Pub. Date: Feb. 15, 2024

(54) FLUID CONTAINER DEVICE COMPRISING A SEPTUM MEMBER, AND METHOD OF DELIVERING FLUID FROM SUCH A DEVICE

(71) Applicant: BIO-RAD EUROPE GMBH, Basel (CH)

(72) Inventors: Stéphane CACHO, CHAUCONIN-NEUFMONTIERS (FR); Jonathan VAN LOO, DANNE ET QUATRE VENTS (FR); Franck MULLER, STRASBOURG (FR); Vivien HUMBLOT, DUNTZENHEIM (FR); Armelle BAUMGARTEN, STRASBOURG (FR); Albert KOCH, BETTWILLER (FR); Justine BARBIER, FROUZINS (FR); Cyril BECARD, STRASBOURG (FR)

(21) Appl. No.: 17/766,545

(22) PCT Filed: Sep. 24, 2020
(86) PCT No.: PCT/EP2020/076694

§ 371 Date: Apr. 5, 2022

(30) Foreign Application Priority Data
Oct. 7, 2019 (EP) 19201676.4

(51) Int. Cl. B01L 3/00

(52) U.S. Cl. CPC B01L 3/523; B01L 2300/0672; B01L 2300/044; B01L 2200/16; B01L 2400/0487; B01L 2200/027

(57) ABSTRACT

A fluid container device for delivering fluid from a vessel and including a container assembly including a first container having a first opening, a vessel having a second opening, the vessel being mounted within the first container such that the first opening and the second opening are in alignment, and a septum member mounted on to the first and second openings.

### TECHNICAL FIELD

The present disclosure relates to the field of storage and delivery of liquids.

The present disclosure also relates to a fluid container device, particularly comprising a first container and a vessel mounted within the first container and designed for holding a fluid, and a method of dispensing a fluid using the fluid container device.

### BACKGROUND

Instrument and apparatus systems that are used for wet chemistry often requires containers for the storage and delivery of liquids, such as reagents, diluents, solvents, and other fluids, to the instruments and apparatus systems. Exemplary wet chemistry instruments or apparatus systems include high pressure liquid chromatography (HPLC) instruments, ultra-high pressure liquid chromatography (UHPLC) instruments, or other such assay chemistry instrumentation.

Wet chemistry instruments, systems, and apparatus, and the related techniques, have become increasingly sophisticated and complex, allowing for the analysis of multiple samples, utilizing a variety of different solvent, buffer, diluent, and/or reagent fluid, many of which can be expensive or time-consuming to produce. Accordingly, it is important that wet chemistry instruments, systems, and apparatus efficiently distribute fluids in precise volumes for the duration of a testing technique, minimizing any loss of fluids to waste or error.

There is also a need to offer fluid container devices at lower costs, while still working with multiple wet chemistry instruments, apparatus, systems, and related techniques, particularly as a generic fluid container device.

There is also a need to reduce the environmental impact of such fluid container device.

### SUMMARY

There is provided in accordance with one aspect of the present disclosure a fluid container device for delivering fluid from a vessel, including a container assembly including:
a first container having a first opening;
a vessel having a second opening, the vessel being mounted within the first container such that the first opening and the second opening are in alignment;
a septum member mounted to the first and second openings.

Advantageously, the septum member seals the second opening of the vessel, preventing then any leakage and/or drips of the chemical assay fluid when held in the vessel.

The septum member includes a needle-penetrable septum portion, specifically that may be repeatedly pierced or punctured with a hollow slender element (e.g., a cannula, or needle), which can include a trocar with a circumferentially disposed cannula, or any other suitable access mechanism, without limitation. The words “cannula” or “needle,” as used in the present text, encompass any slender element (e.g., a cannula, a needle, a trocar, with a circumferentially disposed cannula, etc.) as known in the art or described herein, without limitation. The needle includes an internal lumen. The needle may be chosen among the needles used with dispensing syringes. The needle may include a front opening and a rear opening, that are both in fluid communication through the internal lumen. The needle may be sensibly rectilinear. Such a septum includes a material, specifically a polymer material (such as a polymer material chosen among silicone polymers and/or elastomers) that seals, under suitable compression, passages formed by puncturing the septum with such an access mechanism. Thus, the septum may be at least partially compressed to facilitate closure of passages formed by puncturing the septum with the access mechanism.

The septum portion in the present text is also referred to as “septum” or “septum material”.

The septum member is in an open configuration when perforated by a needle, thus putting the interior of the vessel into fluid communication with the needle, and therefore with at least one receiving structure of the instrument or apparatus to which the needle is in fluid communication with.

Conversely, when the septum member is not perforated by a needle, the septum member is in a closed configuration.

The needle may be supported by a wet chemistry instrument or equivalent or another device, like an intermediate device (e.g. disposed between the instrument or equivalent and the assembly container, and putting in fluid communication the assembly container with the instrument or equivalent through at least the needle), or preferably a second container, as described here after.

The septum member provides an interface for fluidic communication between the interior of the vessel, and the exterior of the first container, or the exterior of the second container described here after. In embodiments, the needle-penetrable septum portion includes an internal face facing the interior of the vessel and an external face facing the exterior of the vessel, the distance between the internal and external faces defines a depth of the septum portion.

Specifically, the depth is higher than or equal to 1 mm, in particular lower than or equal to 100 mm, more particularly higher than or equal to 5 mm and lower than or equal to 50 mm.

Specifically, the depth is determined in relation with the length of the needle, in order that the needle-penetrable septum portion be perforated by the needle over the entire depth when an end of the needle is in fluid communication with the interior volume of the vessel.

In embodiments, the length of the needle is higher than the depth of the septum material.

In embodiments, a fluid may egress from the interior of the vessel, and through a needle perforating the septum member, by gravity. The vessel having a front portion including the septum member and a rear portion, the rear portion is thus maintained suspended above the front portion, and therefore above the septum member.

In embodiments, a fluid may egress from the interior of the vessel, and through a needle perforating the septum member, when the vessel is subjected to a pressurized environment such that the fluid held within the vessel egresses through the first and second openings, and through the septum member, specifically at a positive pressure. In that case, a container assembly, with or without the second container described here after, can be mounted in various orientation (e.g. vertically, horizontally, in cantilever, above or below an instrument, etc.).

Thus, the vessel may be adapted to be subjected to a pressurized environment.

In embodiments, the vessel is comprised of an elastic, an inelastic, a semi-elastic material or a combination thereof.

In embodiments, the vessel is comprised of a material including one or several polymers, for example selected among: polyesters, polyolefins (like polypropylene, polyethylene), chlorine containing polymers (like PCV), EVA (ethyl-vinyl-acetate), polyurethanes, silicones, or a combination thereof.

In embodiments, the vessel is a flexible container.

In embodiments, the vessel is comprised of at least a first sheet and a second sheet of elastic, inelastic, semi-elastic material, or a combination thereof, the first sheet and second sheet being sealed along their edges. These first and the second sheets are impervious to liquids.

The vessel can be made of material(s) that is/are biologically inert and chemically inert, capable of withstanding at least the range of fluids cited herein, even when having corrosive characteristics.

In embodiments, the first container, and/or the vessel, and/or the second container (as described hereafter) has/(have each) a parallelepiped form, especially a rectangular or square shape.

In embodiments, the first container is a cardboard box.

In embodiments, the first container is comprised of a rigid material, a semi-rigid material, or a combination thereof. This rigid or semi-rigid material may be, or may comprise, a cardboard or carton material or any equivalent material (e.g a recycled material, such as a recycled cardboard or carton material).

In embodiments, the first container includes a body extending between a front side and a rear side. The body may include at least one layer. Each of the front side and/or the rear side may include at least two layers, specifically at least three or four layers. These layers comprise, or are comprised of, a cardboard or carton material.

The term “fluid” as used herein refers to any fluid that may be involved in the functioning of wet chemistry instruments, apparatus or instruments, and specifically to any chemical assay fluid, such as reagents, diluents, buffers, solvents, or to any sample fluid (such as blood, urine, or other biological fluids) and/or other fluids.

Such fluids can be those that are used, or known in the art to be used, as part of a mobile phase in HPLC instrumentation.

In alternative embodiments, fluid, and/or the pressurized delivery of fluid, can be applied toward general life science or diagnostic research fluidic instrumentation, such as instrumentation for ion exchange chromatography, protein purification, solid phase extraction, liquid-liquid extraction, distillation, fractional distillation, fluid separation, magnetic separation, membrane or mesh filtration, flocculation, elutriation, leaching, or other such instrumentation.

In some embodiments, the fluid can be an HPLC solvent, i.e. a fluid specific for use with HPLC instrumentation.

In embodiments, the fluid can be fluid used in separation techniques, filtration techniques, extraction techniques, purification techniques, distillation techniques, flocculation techniques, elution techniques, leaching techniques, or the like.

Exemplary fluids include, but are not limited to, water, acetic acid, acetone, acetonitrile, carbon disulphide, carbon tetrachloride, chlorobenzene, chloroform, cyclohexane, cyclopentane, dichloromethane, 1,2-dichloroethane, diethylether, dimethylformamide, dimethylsulfoxide, dioxin, ethanol, ethyl acetate, fluoroalkanes, heptane, hexane, methanol, methyl ethyl ketone, m-xylene, n-butyl acetate, n-butyl ether, nitromethane, n-methyl pyrollidone, pentane, petroleum ether, 1-propanol, 2-propanol, pyridine, tetrahydrofuran, toluene, trimethylamine, 2,2,4-trimethylpentane, and combinations thereof, or mixtures thereof, or variations thereof.

It is noted that while many embodiments disclosed herein are generally directed to wet chemistry instrumentation and apparatus, the disclosed fluid container device can be used for any appropriately designed instrument that requires the storage and delivery of reagents, buffers, diluents, solvents, or other fluids.

In embodiments, the vessel includes a fluid.

In embodiments, the fluid includes a chemistry assay fluid.

In embodiments, the septum member is in alignment with the first and second openings.

In embodiments, the septum member includes a septum support having a first portion secured to the vessel and a second portion secured to a maintaining septum portion.

The maintaining septum portion is shaped to maintain a septum, at least partially in a compressed state. The maintaining septum portion may include an internal housing receiving the septum. The internal housing is preferably in alignment with the first and second openings.

Specifically, the maintaining septum portion may have an annular shape.

The septum member, or the septum support and/or the maintaining septum portion, may be in an integral single piece construction or may be comprised of several pieces.

In embodiments, the septum support includes a third portion secured to the first container.

In embodiments, the vessel includes a connecting portion secured to the septum member, for instance sandwiched between the first portion of the support member and the first container.

The first portion of the support member may be an annular flange, specifically surrounding at least in part or totally the second opening.

Thanks to this arrangement, when the assay fluid egresses the vessel, the portion of the vessel surrounding the second opening does not prevent the flow of assay fluid through the needle perforating the septum member.

In embodiments, the septum member includes a septum closing hermetically the vessel.

In embodiments, the septum maintaining portion includes an upper portion arranged in the septum support and an upper maintaining piece, the septum being maintained between the upper portion and the upper maintaining piece.

The septum is thus well maintained at least partially compressed in alignment with the first and second openings when the needle is inserted and removed.

In embodiments, the first container includes at least one wall surrounding the vessel, the wall including at least one hole.

When the liquids are dispensed with the use of a pressurized environment, the first space between the exterior of the vessel and the interior of the first container is pressurized. The air injected in the first space passed through the hole(s) (specifically with through hole(s)).

In embodiments, the fluid container device includes a second container having an internal housing, the container assembly being place inside the internal housing.

The second container can be molded, contoured, or constructed in order to fit and interface with an HPLC instrument, or other chemical assay instrument.

In embodiments, the second container is comprised of at least a material selected among: metal(s), polymer(s), reinforced material(s), and a combination thereof, or another appropriate rigid or semi-rigid material(s), in order to generally maintain the form of the second container when under pressure.

In some aspects, the structural walls of the second container can restorably flex, expanding to a degree when under pressure and returning to a base, unexpanded state when not under pressure. The second container may reside within additional external housing, to assist in maintaining the form of and reinforce the second container when under pressure.

In embodiments, the container assembly, or the second container, includes a color-coding, and/or is barcoded, QR-coded, or otherwise labeled with identifying data.

The identity of an individual container assembly can be stored in a computerized database linked to the receiving structure, or the fluid instrument system, such as a HPLC system, so as to keep track of how much fluid has been dispensed from any given container assembly.

In embodiments, the second container is comprised of a material including one or several polymers, for example selected among: polyesters, polyolefins (like polypropylene, polyethylene, UHMWPE), chlorine containing polymers (like PCV), polyamides, polycarbonates, or a combination thereof.

The second container is preferably impervious to the air and adapted to undergo pressurization, e.g. to undergo the extraction of the air within the interior of the second container. The second container includes an introduction opening for the introduction of the container assembly inside its housing and a rear end part arranged to close, notably hermetically, in a reversible manner, the introduction opening. The rear end part may be mechanically fastened, and unfasten, to the introduction opening. When the rear end part is not fastened to the introduction opening, the rear end part may be totally separated from the remaining body of the second container or linked in part to the remaining body.

The second container may be a plastic bottle.

In embodiments, the second container includes a fluid output port member and a needle arranged to perforate the septum to put in fluid communication an interior of the vessel with the fluid output port member.

The needle projects into the interior of the second container.

In embodiments, the needle includes a proximal end and a distal end. The distal end may be linked, or fixed, to the second container, especially to the fluid output port member. The proximal end of the needle may end in an internal volume of the septum member. The septum member may be thus designed to protect the proximal end of the needle, and prevents any perforations of the vessel.

The fluid output port member includes a third opening, in alignment with the first and second openings. Preferably, the fluid output port member includes a valve enabling in a first position to put in fluid communication the needle with at least one receiving structure of the instrument or apparatus to which the fluid output port member is in fluid communication with, and in a second position, to prevent any fluid communication between the needle and the at least one receiving structure of the instrument or apparatus.

The fluid output port member may include a valve head, that is the outer portion of the fluid output port member, and is in communication with the environment external.

In embodiments, the second container includes a gas pressurized input port in fluid communication with, a first space between an exterior of the vessel and an interior of the first container, and a second space between the exterior of the first container and an interior of the second container.

Preferably, the first space between the exterior of the vessel and the interior of the first container is adapted to be pressurized.

Preferably, the second space between the exterior of the first container and the interior of the second container is adapted to be pressurized.

When the septum member is in the open configuration, the gas pressurized input port allows pressurizing of the vessel by pressurizing both the first and second spaces, the fluid held within the vessel thus egresses from the interior of the vessel through the septum member.

In embodiments, the second container includes, or defines, an interstitial volume, and the vessel is fluidly sealed from the interstitial volume.

In embodiments, the interstitial volume includes, or is comprised of, the first space and the second space.

In embodiments, the interstitial volume is fluidly connected to the gas pressurized input port.

In embodiments, the gas pressurized input port and the fluid output port member are configured to interface with a receiving structure, wherein the gas pressurized input port couples with a gas delivery interface on the receiving structure, and wherein the fluid output port member couples with a fluid receiving interface on the receiving structure.

The disclosure of WO 2014/153081, specifically the disclosure of the external container, is incorporated herein in full by reference.

In embodiments, the second container includes one or more feature(s) of the external container described in WO 2014/153081.

In embodiments, second container includes an abutment arranged to abut a first portion of the container assembly.

This abutment helps the correct placing of the container assembly within the second container.

The present disclosure relates according to a second aspect, to a method of delivering fluid from a fluid container device, particularly according to any one of the embodiments according to the first aspect of the disclosure:
providing a container assembly including:
   a first container having a first opening;
   a vessel having a second opening, the vessel being mounted within the first container such that the first opening and the second opening are in alignment, the vessel including a fluid;
   a septum member mounted on to the first and second openings;
providing a receiving structure having a fluid output port member and a needle;
placing the container assembly in the receiving structure and perforating the septum by the needle in order to put in fluid communication an interior of the vessel with the fluid output port member.

The receiving structure may be, preferably a second container (as described herein), or a receiving structure of a wet chemistry instrument, system, or apparatus, or of an intermediate device.

The receiving structure can be an HPLC instrument and the modules within an HPLC instrument, such as pump set, a separation module, or a dilution module.

The septum member is perforated by the needle when placed within the internal housing of the second container.

In embodiments, the receiving structure is a second container including an internal housing receiving the first container; and the first container includes a wall surrounding the vessel and including at least one hole in fluid communication with a first space, between the exterior of the vessel and the interior of the first container, and a second space, between the exterior of the first container and the interior of the second container; and the second container includes an gas pressurized input port in fluid communication with the first space and the second space. The method further includes the injection of gas, specifically air, through the gas pressurized input port causing the egress of the fluid from the vessel.

In embodiments, the fluid includes chemistry assay fluid.

In embodiments, the method includes coupling the gas pressurized input port to a pressurization system and coupling the fluid output port member to a receiving structure, and compressing the vessel by filling the first and second spaces, or the interstitial volume, with pressurized gas through the gas pressurized input port, and delivering the fluid from within the vessel, specifically at a positive pressure, to the receiving structure through the fluid output port member, and at the same time through the needle perforating the septum member.

In embodiments, the gas, includes, or is, air.

In embodiments, the gas is pressurized to less than about 0.5 bar to 4.0 bar.

In embodiments, the method includes drawing atmospheric air into the pressurization system.

In embodiments, the method includes, after delivering the fluid, depressurizing the interstitial volume, or the first space.

In embodiments, the method includes monitoring the amount of fluid held within the vessel.

In embodiments, the container assembly is replaced by another equivalent assembly container inside the housing of the second container.

The assembly container is preferably a single-use assembly container. When the vessel is empty, or there is a need to change it, the assembly container is removed from the receiving structure, and replaced by an equivalent assembly container, specifically as described herein.

We understand by another equivalent assembly container, any assembly container according to any embodiment. The fluid may change for example from a container assembly to another assembly container.

The second container is advantageously reusable.

In the state of the art, a flexible container is placed within the interior of a plastic bottle. The flexible container is thus sealed by the valve of a fluid output port member supported by the plastic bottle. When the flexible container is empty or needs to be replaced, the flexible container and the outer shell (or plastic bottle) are thrown out, and replaced by both another flexible container and plastic bottle.

In one embodiment, the container assembly is discarded, while the second container may be reprocessed.

In embodiments, when the assembly container is replaced by another equivalent assembly container, the second container remains housed in the instrument or apparatus.

The fluid output port member of the second container may remain in fluid communication with the apparatus or instrument while the operator replaces the assembly container by another one.

The fluid container device may include a device preventing leakage and/or drips from the needle of the second container.

In embodiments, when the assembly container is replaced by another equivalent assembly container, the second container and the assembly container are removed. The assembly container is then replaced by another equivalent assembly container within the housing of the second container. Then, the assembly container, housed within the second container, is placed in the instrument or apparatus.

The variants, embodiments, definitions according to the first and second aspects of the disclosure may be combined together independently of each other, unless otherwise defined.

### BRIEF DESCRIPTION OF THE DRAWINGS

The container and assembly and methods of its use will be better understood upon reading the following description of an embodiment given by way of non-limiting example, with reference to the appended drawings, in which:

FIG. 1 represents a schematic perspective view of an example of a fluid container device;

FIG. 2 represents schematically the front face of the fluid container device represented in FIG. 1;

FIG. 3 represents schematically the fluid container device along the sectional plane III-III represented in FIG. 2;

FIG. 4 represents an enlarged view of the part A represented in FIG. 3;

FIG. 5 represents schematically a variant of the first container represented in FIGS. 1 to 4.

### DETAILED DESCRIPTION

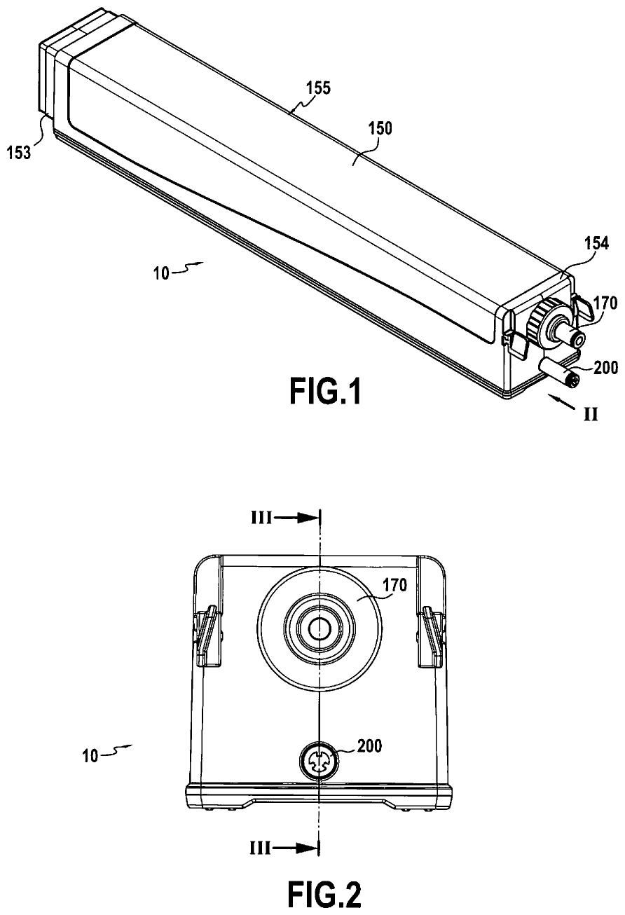

The fluid container device 10 represented in FIGS. 1 to 4, for delivering a fluid, includes a container assembly 20 including:
a first container 30 having a first opening 35;
a vessel 40 having a second opening 45, the vessel 40 being mounted within the first container 30 such that the first opening 35 and the second opening 45 are in alignment; and
a septum member 50 mounted on to the first 35 and second 45 openings. The septum member 50 is in alignment with the first 35 and second openings 35, specifically along the longitudinal axis L1.

The septum member 50 includes a septum support 60 having a first portion 62 secured to the vessel 40, and a second portion 64 secured to a maintaining septum portion 70. The septum maintaining portion 70 includes, in this specific example, an upper portion 75 arranged in the septum support 60 and an upper maintaining piece 78. The septum member 50 includes a septum 80 maintained between the upper portion 75 and the upper maintaining piece 78, at least partially in a compressed state. The septum 80 closes hermetically the vessel 40, especially its second opening 45. The maintaining septum portion 70 includes an internal housing 85 receiving the septum 80. The internal housing 85 is preferably in alignment with the first 35 and second 45 openings. The maintaining septum portion 70 has an annular shape. In embodiments, the upper maintaining septum piece 78 is a cap including a through hole giving access to the septum 80 for being perforated by a needle.

In particular, the upper maintaining piece 78 is clipped onto the upper portion 75 of the septum support 60. The upper maintaining piece 78 includes a protrusion 87, for example a finger, which is engaged with a recess 89 formed in the upper portion 75. The recess 89, in this specific example, has a substantially annular shape.

The upper portion 75, the upper maintaining piece 78, the septum support 60, and the first portion 62 of the septum support 60, may also be in an integral single piece construction.

The vessel 40 includes a connecting portion 42 secured to the septum member 50, especially sandwiched between the first portion 62 and the first container 30.

The first portion 62 of the support member 60 is, in this specific example, an annular flange, specifically surrounding totally the second opening 45.

The septum support 60 includes a third portion 100 secured to the first container 30. The third portion 100 includes a first threaded engaging surface 110, arranged on an external surface of the septum support 60. The fluid container device 10 includes also a second threaded engaging surface 120, arranged on an internal surface of an annular connecting piece 130. The first 110 and second 120 threaded engaging surfaces are engaged to each other by screwing.

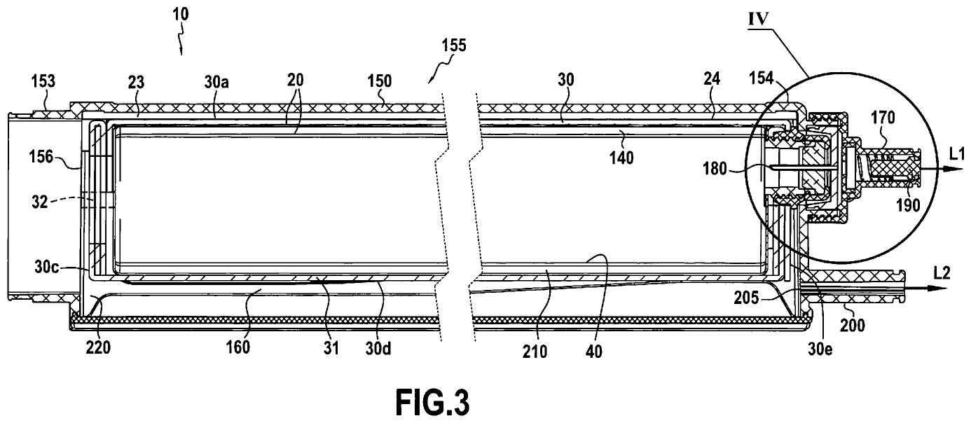

The fluid container device 10 also includes a second container 150 having an internal housing 160, the container assembly 20 being placed inside the internal housing 160 as represented in FIG. 3.

The first container 30 includes at least one wall 31 surrounding the vessel 40, the wall 31 including at least one hole 32. The first container 30 has, in this specific example, a rectangular shape, and includes a top side 30a, a bottom side, a right side 30b, a left side, a front side, and a rear side 30c. The holes 32 can be distributed in at least one of these sides, and in this example the right 30b and left sides, and in the rear side 30c. As a general manner, the number, the size and the distribution of the hole(s) 32 among the sides of the wall 31 are determined in order to pressurize the vessel 30 for dispensing the assay fluid held within the vessel 40, as it will be further described below.

The second container 150 includes a fluid output port member 170 and a needle 180. The needle 180 is in alignment with the longitudinal axis L1. The fluid output port member 170 includes a valve 190, especially functioning with a valve spring.

The second container 170 includes also an gas pressurized input port 200 (see FIG. 3) in fluid communication with, a first space 210 between an exterior of the vessel 40 and an interior of the first container 30, and a second space 220 between the exterior of the first container 30 and an interior of the second container 150.

The gas pressurized input port 200 includes a third opening 205, in alignment with an axis L2. In this example, L1 and L2 are parallel to each other.

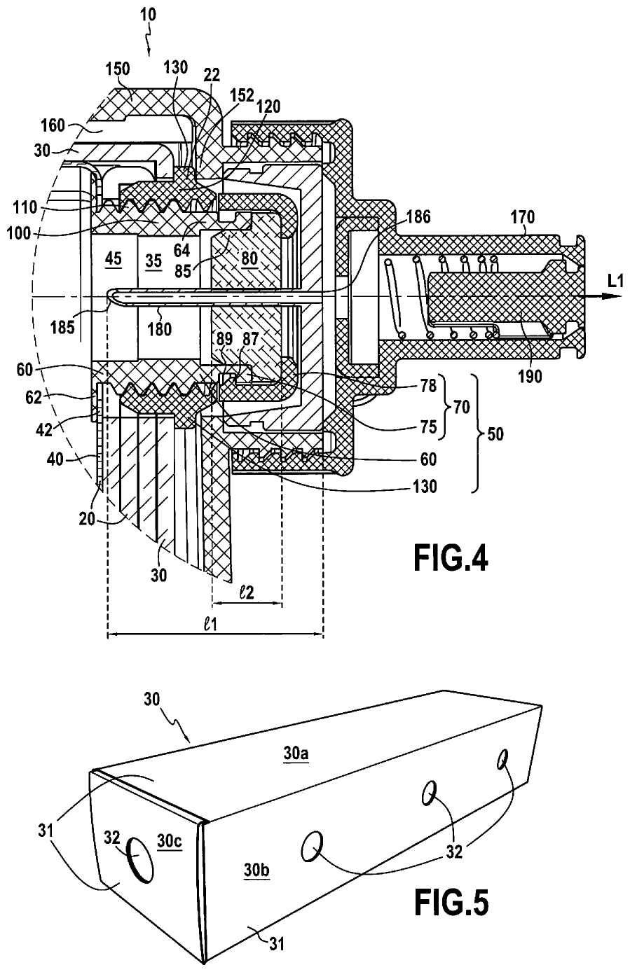

The second container 150 includes an abutment 152 arranged to abut a first portion 22 of the container assembly 20. The container assembly 20 includes a rear part 23 and a front part 24, the first portion 22 is supported by the front part 24, facing the front part 154 of the second container 150. In this specific example, the first portion 22 is supported by the annular connecting piece 130, as represented in FIG. 4. The first portion 22 may be supported by another element of the container assembly 20, such as the first container 30 or the septum member 50, or the septum support 60.

The length 11 of the needle 180 is higher than the depth 12 of the septum 80 in order that the proximal end 185 of the needle 180 is in fluid communication with the interior of the vessel 40. The distal end 186 of the needle 180 is in fluid communication with the fluid output port member 170. The needle 180 includes an internal lumen for the dispensing of the fluid hold in the vessel 40.

The second container 150 includes an introduction opening 156 for the introduction of the container assembly 20 inside the internal housing 160 and a rear end part 153 arranged to close, notably hermetically, in a reversible manner, the introduction opening 156. The rear end part 153 may be mechanically fastened, and unfastened, to the introduction opening 156. When the rear end part 153 is not fastened to the introduction opening 156, the rear end part 153 may be totally separated from the remaining body 155 of the second container 150 or linked in part to the remaining body 155.

### Modes of Operating the Fluid Container Device

The vessel 40 may be filled up with a fluid, for example a chemical assay fluid, like a buffer solution, with a filling needle. The filling needle is in fluid communication with a storage tank including the fluid.

The vessel 40 may also be filled up with a fluid prior being assembled with the septum member 50 and the first container 30 to make the container assembly 20.

Then, the rear end part 153 is unfastened from the body 155, thus given access to the introduction opening 156. The container assembly 20 is then introduced through the introduction opening 156, and placed inside the internal housing 160 of the second container 150, in order that its front part 24 abuts against the abutment 152. Concomitantly, the needle 180 perforates the septum member 50, especially the septum 80, the proximal end 185 is free from the septum 80 and ends in the internal volume of the septum member 50, in fluid communication with the interior of the vessel 40. In particular, the proximal end 185 of the needle 180 does not end directly in the interior of the vessel 40, and is protected by the septum member 50. Thus, there is no risk that the vessel be punched by the proximal end 185 of the needle 180.

The read end part 153 is fastened to the body 155, thereby closing, notably hermetically, the introduction opening 156. The fastening and unfastening elements for fastening and unfastening the rear end part 153 to the body 155 could be any mechanical elements known in the state of the art as long as they permit an air impervious fastening.

The second container is then placed in fluid communication with a receiving structure, like a wet chemistry instrument or apparatus, through its fluid output port member 170. The second container may also be already in fluid communication with a receiving structure, when the container assembly 20 is placed within the internal housing 160.

Then, the internal volume 160 is pressurized by pressurizing the first space 210 and the second space 220 through the gas pressurized input port 200 (see FIG. 3). The (through) hole(s) arranged in the wall 31 of the first container 30 makes it possible to apply pressure around to the vessel 40. The liquid held within the vessel 40 egresses from the vessel 40 and enters the internal lumen of the needle 180, and then the valve 190 of the fluid output port member 170 to reach the receiving structure.

When the vessel 40 is substantially empty or when necessary, the assembly container 20 is removed from the second container 150, and replaced by another equivalent assembly container 20.

The container assembly 20 is a single use container assembly, and therefore discarded.

The replacement of the assembly container 20 may also be done on the second container 30 which has been previously extracted from the receiving structure. Then, the fluid container device, including a new assembly container and the reusable second container, is inserted into the receiving structure.

The fluid container device 10 may also be operated only with the assembly container 20 (without the second container 40). In that case, the fluid is dispensed by gravity. The needle 180 is therefore supported directly by a receiving structure or an intermediate device in fluid communication with the receiving structure.

1-17. (canceled)

18. A fluid container device for delivering fluid from a vessel, said fluid container device comprising a container assembly, said container assembly comprising:
a first container having a first opening;
a vessel having a second opening, the vessel being mounted within the first container such that the first opening and the second opening are in alignment;
a septum member mounted to the first and second openings.

19. The fluid container device according to claim 18, wherein said septum member is in alignment with the first and second openings.

20. The fluid container device according to claim 18, wherein said septum member comprises a septum support having a first portion secured to the vessel, and a second portion secured to a septum maintaining portion.

21. The fluid container device according to claim 20, wherein the septum support comprises a third portion secured to the first container.

22. The fluid container device according to claim 18, wherein the vessel comprises a connecting portion secured to the septum member, preferably sandwiched between the first portion of the support member and the first container.

23. The fluid container device according to claim 22, wherein the connecting portion secured to the septum member is sandwiched between the first portion of the support member and the first container.

24. The fluid container device according to claim 18, wherein the septum member comprises a septum hermetically closing the vessel.

25. The fluid container device according to claim 20, wherein the septum maintaining portion comprises an upper portion arranged in the septum support and an upper maintaining piece, the septum being maintained between the upper portion and the upper maintaining piece.

26. The fluid container device according to claim 18, wherein the first container comprises at least one wall surrounding the vessel, said wall comprising at least one hole.

27. The fluid container device according to claim 18, wherein the vessel comprises a fluid.

28. The fluid container device according to claim 27, wherein the fluid comprises a chemistry assay fluid.

29. The fluid container device according to claim 18, wherein said device comprises a second container having an internal housing, said container assembly being placed inside said internal housing.

30. The fluid container device according to claim 29, wherein the second container comprises a fluid output port member and a needle arranged to perforate the septum to put in fluid communication an interior of the vessel with the fluid output port member.

31. The fluid container device according to claim 29, wherein the second container comprises a gas pressurized input port in fluid communication with, a first space between an exterior of the vessel and an interior of the first container, and a second space between the exterior of the first container and an interior of the second container.

32. The fluid container device according to claim 29, wherein the second container comprises an abutment arranged to abut a first portion of the container assembly.

33. A method of delivering fluid from a fluid container device, the method comprising:
providing a container assembly comprising:
a first container having a first opening;
a vessel having a second opening, the vessel being mounted within the first container such that the first opening and the second opening are in alignment, the vessel comprising a fluid;
a septum member mounted on to the first and second openings;
providing a receiving structure having a fluid output port member and a needle;
placing the container assembly in the receiving structure and perforating the septum member by the needle in order to put in fluid communication an interior of the vessel with the fluid output port member.

34. The method according to claim 33 wherein the receiving structure is a second container.

35. The method according to claim 33, wherein
the receiving structure is a second container comprising an internal housing receiving the first container,
the first container comprises a wall surrounding the vessel and comprising at least one hole in fluid communication with a first space, between the exterior of the vessel and the interior of the first container, and a second space, between the exterior of the first container and the interior of the second container, and
the second container comprises gas pressurized input port in fluid communication with the first space and the second space, and
wherein said method comprises the injection of a gas through the gas pressurized input port causing the egress of the fluid from the vessel.

36. The method according to claim 33, wherein the fluid comprises chemistry assay fluid.
